(19) United States
(12) Patent Application Publication
(10) Pub. No.: US 2005/0169815 A1
(43) Pub. Date: Aug. 4, 2005

(54) System for chemical experiments

(75) Inventors: Peter John van den Brink, Driebergen (NL); Martin Smit, Haarlem (NL); Gerardus Johannes Maria Gruter, Heemstede (NL); Rene de Ruiter, Enkhuizen (NL); Jan Cornelis van der Waal, Den Haag (NL)

Correspondence Address: HOFFMANN & BARON, LLP, 6900 JERICHO TURNPIKE, SYOSSET, NY, 11791, US

(73) Assignee: Avantium International B.V.

(21) Appl. No.: 10/988,070

(22) Filed: Nov. 12, 2004

Related U.S. Application Data
(63) Continuation-in-part of application No. PCT/NL02/00721, filed on Nov. 11, 2002.

(30) Foreign Application Priority Data
May 13, 2002 (WO) PCT/EP02/05322
Jul. 22, 2002 (WO) PCT/NL02/00493

(51) Int. Cl. B01J 19/00

(52) U.S. Cl. 422/130

(57) ABSTRACT

A system for performing a chemical experiment comprises a reactor vessel having a wall defining a reaction chamber for receiving one or more fluids performing a chemical reaction. An analysis apparatus is located remote from said reactor vessel for analysing samples of said one or more fluids removed from said reaction chamber. Sampling means and transfer means are provided which are adapted for removing samples of said one or more fluids from said reaction chamber and transferring said samples to said analysis apparatus. The sampling and transfer means comprise a sample removal passage in communication with said reaction chamber and a sample transfer passage connected to said sample removal passage and extending to said analysis apparatus. The sample removal passage establishes an open communication between said reaction chamber and said sample transfer passage and the sample removal passage contains a flow restrictor. A pressure drop over said flow restrictor causes the removal of said samples from the reaction chamber.

### CROSS-REFERENCE TO RELATED APPLICATIONS

This application is a continuation-in-part of International Application No. PCT/NL02/00721, filed Nov. 11, 2002, which claim the benefit to International Application No. PCT/EP02/05322, filed May 13, 2002 and to International Application No. PCT/NL02/00493, filed Jul. 22, 2002, the contents of which are incorporated by reference herein.

### FIELD OF THE INVENTION

The present invention relates to a system for chemical experiments. The system has a reactor vessel having a wall defining a reaction chamber for receiving one or more fluids performing a chemical reaction. The system further has an analysis apparatus remote from said reactor vessel for analysing samples of said one or more fluids removed from said reaction chamber.

Sampling means and transfer means are provided. These sampling and transfer means are adapted for removing samples of said one or more fluids from said reaction chamber and transferring said samples to said analysis apparatus.

The sampling and transfer means comprise a sample removal passage in communication with said reaction chamber and a sample transfer passage connected to said sample removal passage and extending to said analysis apparatus.

### BACKGROUND OF THE INVENTION

When performing chemical experiments in a reactor it is highly useful to be able to follow the extent of the reaction as a function of time. This often is done by taking representative samples from the reactor at regular intervals, and analysing the composition of the samples via analytical methods. The information obtained by this allows optimising the time needed for certain reactions, and also allows the determination of the kinetics of such a reactor.

Known systems employ a valve or a syringe arrangement in order to remove samples from the reaction vessel during the experiment. As the temperature and pressure in the reactor vessel can be high, an expensive and complex valve or syringe arrangement is required. Also the chemicals involved can be aggressive or dangerous and render an even more complex valve or syringe arrangement necessary.

These and other drawbacks of such known systems are especially relevant if the system is applied in the field of high throughput experimentation. In this field a significant number of small-scale chemical experiments are conducted in parallel. A further drawback of the known systems is the size of the valve or syringe arrangement, which is basically to big to serve in the field of high throughput experimentation as the reactor vessels are then usually placed closely spaced next to each other. Also, when performing such small scale experiments, the internal volume of most known sampling systems is too large compared to the internal volume of the reactor. This may result in a compositional change within the small-scale reactor which may result in an undesired change of kinetics.

Analogous to this, when testing catalysts in small scale continuous flow reactors relative small amount of reactor effluent is available for analysis. This collection of the effluent especially becomes difficult in the many cases where the reactor has to be kept at high pressures.

### OBJECTS OF THE INVENTION

The present invention has as an object to provide an improved system for conducting chemical experiments, wherein the sampling involves less complex and expensive arrangements than the prior art arrangements.

A further object of the invention is to provide an improved system for conducting chemical experiments, which is in particular suitable for high throughput experimentation.

A further object of the invention is to provide an improved system wherein small samples can be transferred over a significant distance from the reactor vessel to the analysis apparatus, without loss of quality of the sample.

A further object of the invention is to provide an improved system wherein the negative effect of residence time distribution on the removed samples is minimal.

### SUMMARY OF THE INVENTION

The present invention achieves one or more of the above mentioned objects by providing a system for performing a chemical experiment, wherein a sample removal passage establishes an open communication between said reaction chamber and said sample transfer passage, and wherein said sample removal passage contains a flow restrictor, and wherein a pressure drop over said flow restrictor causes the removal of said samples from the reaction chamber.

The proposed flow restrictor and the pressure drop across said flow restrictor, in conjunction with the viscosity of the sample, essentially determine the sample flow from the reactor vessel. The flow restrictor has a flow resistance, which is significantly higher than the flow resistance of the transfer passage downstream of said flow restrictor.

Preferably the flow restrictor has a constant restriction value during the experiment.

In a practical embodiment the flow restrictor has constant dimensions, which are preferably optimised in view of the viscosity of the sample and the desired sample flow.

Preferably said flow restrictor forms said sample removal passage.

Preferably the system further includes a transfer fluid supply means for feeding a transfer fluid into said transfer passage, said transfer fluid transferring said sample through said transfer passage to said analysis apparatus.

The use of a transfer fluid, preferably having a flow rate significantly larger than the flow of the sample, allows overcoming multiple problems associated with a small volume and/or volumetric flow rate of the sampled fluid from the reactor vessel.

For instance it allows a rapid transfer of the sample to the analysis apparatus. It also allows a significant distance of transfer without problems relating to the time span required for the transfer.

Preferably a pressure regulator is provided in said transfer passage, more preferably a backpressure regulator, for controlling the pressure of the transfer fluid and thereby the pressure drop over the flow restrictor. In a further preferred embodiment the (back-) pressure regulator is adapted to maintain an essentially constant pressure drop across the flow restrictor.

The use of a pressure regulator will in practice allow a practical internal diameter of the flow restrictor between the reaction chamber and the transfer passage, which is in particular advantageous if the pressure in the reaction chamber is high.

In a preferred embodiment the sample removal passage is essentially formed by said flow restrictor and wherein said sample is received by said transfer fluid directly downstream of said flow restrictor.

The transfer fluid supply means can include a pump or a pressurized transfer fluid vessel having an outlet restricted by a fixed restrictor or an adjustable restrictor such as a needle valve.

The transfer fluid supply means can be adapted to supply a constant flow of transfer fluid, such that a continuous sample flow through the flow restrictor is established.

In an alternative arrangement the flow of transfer fluid is discontinuous, preferably periodic, so that in absence of flow of transfer fluid a sample in the form of a slug is formed in the transfer passage which slug is then transferred as the flow of transfer fluid is established once again. In a practical embodiment a slug has a volume between 1 microliter and 10 micro liter.

The transfer fluid can be chosen such that the transfer fluid and the sample are immiscible. It is also conceivable that the transfer fluid is a solvent for the sample.

The transfer fluid can be a liquid or a gas.

In a possible embodiment the invention proposes that the transfer fluid supply means are adapted to create an alternating flow of a transfer fluid and a transfer gas.

It is envisaged that one or more additives may be added to the transfer fluid. For instance an additive may serve as an internal standard, which is useful for the analysis. The additive may also assist in conditioning the sample. It may react with one or more of the components of the sample making it e.g. less reactive or easier to analyse. The additive may also act as a poison for any catalyst present, thus avoiding continuation of the reaction within the transfer passage.

Those who are skilled in the art will understand that the type of additive will depend on the type of chemistry in the reactor and on the desired effect. It will be evident that the system of the invention is in particular suited for use where an additive is added to the transfer fluid, in particular a conditioning agent. The sample passes through the sample removal passage quickly and then is already in contact with the transfer fluid including the additive. If the additive has the effect of stopping any change of composition of the sample, this method allows the experimentalist to take representative samples of the reaction.

It was found advantageous that the dimensions of the flow restrictor should be adapted such that the volumetric sample flow per minute amounts to 1/100,000- 1/10, preferably 1/50,000- 1/100, more preferably 1/10,000- 1/1000, of the effective reaction chamber volume.

For continuous flow reactor vessels it was found advantageous that the dimensions of the flow restrictor was adapted such that at the given conditions during the experiment the volumetric sample flow per minute amounts to 0.001 to 0.99, preferably 0.01 to 0.95 and most preferably 0.1 to 0.9 of the volumetric flow of the reactor effluent.

In a practical embodiment of the system the flow of samples through said flow restrictor is between 1 and 500 microliter per minute.

In a possible embodiment the flow restrictor comprises one or more capillaries, preferably in parallel if multiple capillaries are used.

Preferably the capillary or bundle of capillaries has a ratio between the length and the fourth order of internal diameter between 100 and 10⁷ meter per mm⁴.

In another possible embodiment the flow restrictor is a porous body, e.g. a porous membrane or a porous frit.

In yet another embodiment the flow restrictor is a sieve.

In a preferred embodiment the flow restrictor comprises one of more microholes formed in a suitable body, preferably a single microhole. Bodies having well defined microholes with close manufacturing tolerances are commercially available. Usually the microhole is formed using a laser device.

If the flow restrictor consists of a single microhole, preferably the microhole has an internal diameter between 1 and 50 micrometer. If the flow restrictor consists of a multitude of parallel microholes even smaller internal diameters may be chosen.

In a preferred embodiment the microhole is formed in the wall of the reactor vessel, so that the samples are removed via this microhole.

In a further preferred embodiment a mounting aperture is present in the wall of the reactor vessel and an insert provided with one or more microholes is mounted in said aperture, preferably in a removable manner.

In a preferred embodiment the insert is a circular disc, which is a commercially available form.

In yet another preferred embodiment the insert is a tubular element protruding through said aperture into the reaction chamber and being provided with said one or more microholes at a location inside said chamber. Such an insert could also be referred to as a probe.

In a practical embodiment the tubular element has an axial end inside the reaction chamber and the microhole(s) is mounted at said axial end.

In a very advantageous embodiment the insert is a coaxial assembly of an inner tubular element and an outer tubular element, wherein the outer tubular element is provided with one or more microholes in communication with the reaction chamber, and wherein the assembly allows for a circulation of transfer fluid to transfer the samples which passed through the microhole(s).

In order to avoid or reduce the problem of clogging of the flow restrictor it is preferred to employ a filter mounted before the entrance of the sample removal passage, preferably directly upstream of the flow restrictor. The filter preferably has a pore size smaller than the internal diameter of the flow restrictor.

Another measure to avoid or reduce the problem of clogging of the flow restrictor is to provide clogging elimination means, such as a needle piercing the bore of the flow restrictor at intervals or a backwash arrangement wherein fluid is flushed back through the flow restrictor.

In a preferred embodiment the reactor vessel is a batch reactor vessel adapted for receiving a liquid having a liquid surface and the entrance of the sample removal passage is located below said liquid surface.

In another embodiment the reactor vessel is a continuous flow reactor and the entrance is located at the downstream end of the flow reactor.

In a practical embodiment of the system the sampling and transfer means are adapted for samples having a temperature above 100 Celsius.

In a preferred embodiment each reactor vessel has a reactor outlet connected to an effluent conduit for discharging effluent from the reaction chamber, each effluent conduit being connected to a pressure controller for controlling the pressure in the reaction chamber. The sample removal passage is then in open communication with the interconnected reaction chamber and effluent conduit upstream of the pressure controller.

In a preferred embodiment a first gas/liquid separator is received in the effluent conduit, said first gas/liquid separator having a first outlet connected to the effluent conduit and a second outlet for separated gas or liquid, and the sample removal passage is connected to said second outlet.

In a further variant a second gas/liquid separator is received in the effluent conduit downstream of the first gas/liquid separator, said second gas/liquid separator having a first outlet connected to said effluent conduit and a second outlet for separated gas or liquid. A second sample removal passage is then connected to said second outlet.

In a preferred embodiment the system comprises multiple reactor vessels, the effluent conduits being connected to a common pressure controller for controlling the pressure in the reaction chambers. The system comprises multiple sample removal and transfer passages, each sample removal passage being in open communication with an associated effluent conduit. Preferably the multiple sample removal and transfer passages are connected to a selector valve interposed between said sample removal and transfer passages and an analysis apparatus. As the sample removal passages provide a high flow resistance the selector valve can be operated at a pressure far below the operating pressure of the reactor vessels, preferably at ambient pressure, which allows for a simple design of the selector valve.

In a preferred embodiment the multiple sample removal and transfer passages are connected to a parallel analysis apparatus for conducting analysis of sample fluids from the reactors in parallel. In a preferred variant thereof the multiple sample removal and transfer passages are connected to a parallel sample collector. Such a parallel sample collector comprises an array of outlets, each in communication with a sample removal and transfer passage, and an array of collection containers positionable so that samples are deposited in parallel in said containers.

It is envisaged that the system can comprise diluent feed means for diluting effluent emerging from a reactor vessel upstream of the connection of the sample removal and transfer passage.

The analysis apparatus can be any suitable apparatus. In particular it is envisaged that the analysis apparatus is a sampling collector robot, where sample reservoirs are filled at intervals during the experiment, which are later analysed using a further analysis apparatus. It is however also envisaged that the sample is directly analysed by a suitable on-line analysis apparatus, such as a chromatographic, spectroscopic technique or any other analytical system. In case of a chromatographic technique (e.g. gas chromatography, liquid chromatography) a sample introduction valve will be needed to transfer the sample to the column. In case of a spectroscopic technique, such as for instance UV-VIS (Ultra-violet visible spectroscopy), NIR (Near infrared spectroscopy or fluorescence spectroscopy the sample may be transferred through an optical cuvette.

It will be apparent to the man skilled in the art that the invention also relates to combinations of and variations on the measures explained above.

The present invention further relates to a system for conducting parallel chemical experiments. In that case a multitude of reactor vessels is sampled in parallel allowing increased throughput of experiments per unit of time. Another advantage of such parallel system is some of the elements of the system are used more efficiently. For instance it is envisaged that only one transfer fluid supply system and only one analysis apparatus will be needed for the sampling of a multitude of reactors, provided that the appropriate splitting and selecting means are present.

The present invention further relates to a chemical reactor provided with a sample removal arrangement according to the invention.

The present invention further relates to methods for conducting chemical experiments, in particular parallel small-scale chemical experiments, wherein use is made of a system as explained above.

The present invention further relates to a totally parallel system, wherein experiments are conducted in parallel in multiple reactor vessels and samples are removed in parallel from these vessels and fed to a parallel sample collector.

Preferred embodiments of the invention will now be described referring to the drawings.

### BRIEF DESCRIPTION OF THE DRAWING

FIG. 1 shows schematically a first exemplary embodiment of a system according to the invention.

FIG. 2 shows schematically a second exemplary embodiment of a system according to the invention.

FIG. 3 shows schematically a third exemplary embodiment of a system according to the invention.

FIG. 4 shows schematically a fourth exemplary embodiment of a system according to the invention.

FIG. 5 shows schematically a fifth exemplary embodiment of a system according to the invention.

FIG. 6 shows a graph relating to a test conducted with the system of FIG. 5.

FIG. 7 shows schematically a sixth exemplary embodiment of a system according to the invention.

FIG. 8 shows schematically a seventh exemplary embodiment of a system according to the invention.

FIG. 9 shows schematically an eighth exemplary embodiment of a system according to the invention.

FIG. 10 shows schematically a ninth exemplary embodiment of a system according to the invention.

FIG. 11 shows schematically a tenth exemplary embodiment of a system according to the invention.

FIG. 12 shows schematically an eleventh exemplary embodiment of a system according to the invention.

FIG. 13 shows schematically a twelfth exemplary embodiment of a system according to the invention.

FIG. 14 shows a parallel sample collector which can be used in a system according to the invention.

### DETAILED DESCRIPTION OF PREFERRED EMBODIMENTS

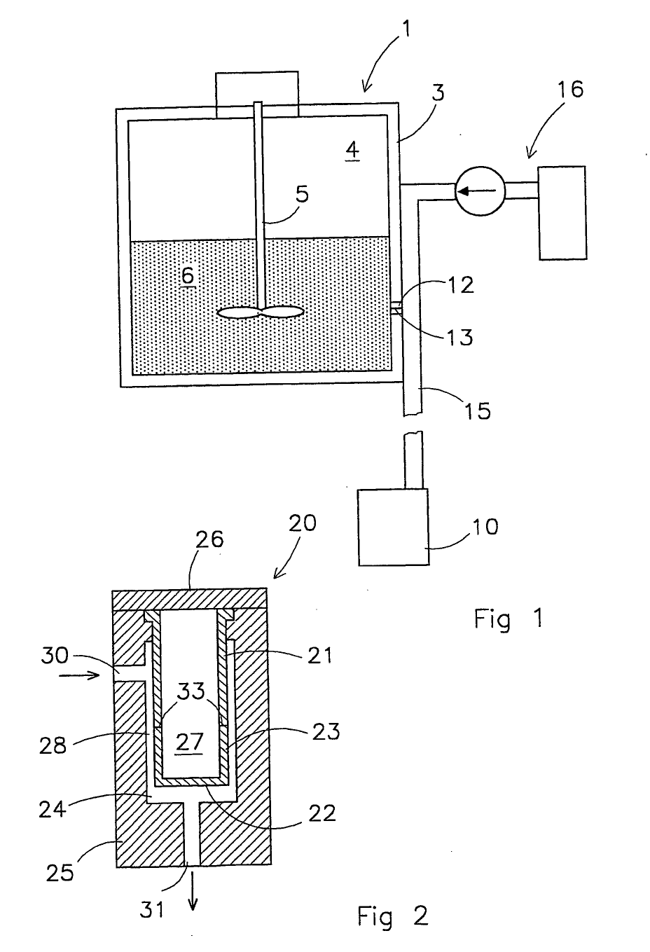

In FIG. 1 a first exemplary embodiment of a system for conducting a chemical experiment is shown. The system comprises a batch reactor vessel 1 having a wall 3 defining a reaction chamber 4. The vessel 1 is of the stirred tank type having a stirrer 5 for stirring the liquid chemical mixture 6 involved in the chemical experiment.

In order to determine relevant parameters of the experiment an analysis apparatus 10 is provided remote from said reactor vessel 1 for analysing samples of the reaction mixture 6 removed from the reaction chamber 4.

In the wall 3 of the reactor vessel 1 an aperture is provided wherein an insert 12 is mounted, in this embodiment a circular metal disc. The insert 12 is provided with a single microhole 13 (shown on exaggerated scale here). The microhole 13 is preferably formed using a laser device in a metallic insert 12. For instance the microhole has an internal diameter between 1 and 50 micrometer and a length of between 1 and 10 millimetres.

In another embodiment (not shown) the microhole 13 is formed in the wall 3 of the reactor vessel 1.

The insert 12 with microhole 13 therein is located below the liquid surface of the reaction mixture 6 and defines a sample removal passage as well as a flow restrictor as will be explained below.

Outside the reactor vessel 1 a transfer fluid conduit 15 is provided which extends between a source of transfer fluid 16 and the analysis apparatus 10 and is in communication with the microhole 13.

A flow of transfer fluid is established in said transfer fluid conduit 15 towards the analysis apparatus which flow passes along the insert 12 with microhole 13. Therefore a sample passing through the microhole 13 immediately enters the transfer fluid conduit 15 and is transported by said transfer fluid to the analysis apparatus 10. Thus the transfer fluid conduit 15 forms a sample transfer passage downstream of the sample removal passage 13.

It will be apparent from the FIG. 1 that the microhole 13 establishes an open communication path between the reaction chamber 4 and transfer fluid conduit 15. There is no valve or syringe arrangement adjacent the reactor chamber as in the prior art systems to control the sample flow from the reaction chamber during the experiment.

It also will be apparent that the internal diameter of the transfer passage (conduit 15 downstream of the insert 12) is significantly greater than that of the microhole 13. As a result the microhole 13 acts as flow restrictor and the pressure drop across the flow restrictor causes the removal of samples from the reaction chamber with a restricted yet sufficient flow rate.

It will be apparent that the microhole 13 has constant dimensions to obtain a constant restriction. In combination with the viscosity of the sample flow as well as the pressure in the reaction chamber during the experiment, the pressure of the transfer fluid creates the pressure drop and thus determines the flow of the sample from the reaction chamber. Engineers, skilled in the art, will be able to calculate such dimensions.

In this arrangement no residence time distribution problems relating to the flow of the sample through the microhole flow restrictor are encountered.

The sample flow can either be continuous or intermittent as will be explained below. Also during the time span of an experiment it will be possible to switch between these modes if desired, e.g. taking into account the kinetics of the experiment.

The transfer fluid supply means 16 can be adapted to supply a constant flow of transfer fluid, such that a continuous sample flow through the microhole 13 is established.

In an alternative arrangement the flow of transfer fluid is discontinuous, preferably periodic, so that in absence of flow of transfer fluid a sample in the form of a slug is formed in the transfer passage which slug is then transferred as the flow of transfer fluid is established once again. It will be apparent that by suitable control of the pressure of the transfer fluid the formation of the slug can be controlled as well.

The transfer fluid can be chosen such that the transfer fluid and the sample are immiscible.

It is also conceivable that the transfer fluid is a solvent for the sample.

The transfer fluid can be a liquid or a gas.

In a possible embodiment the transfer fluid supply means 16 are adapted to create an alternating flow of a transfer fluid and a transfer gas.

In a possible embodiment it is envisaged that the sample in liquid form is evaporated as it enters the transfer fluid passage 16, wherein a transfer gas is present. Heating means could be provided to cause said evaporation or a suitably hot transfer gas could be used.

It can also be envisaged that a circulation of transfer fluid is caused in combination with a separation of transfer fluid and sample near the analysis apparatus. The separated transfer fluid could then be reused for the transfer of further samples.

In case the sampling is performed at intervals it is preferred that the volume of the samples are small with respect to the volume of the reaction chamber as follows from claim 4.

In case the sampling is performed over a significant time span, it is preferred that only a limited part of the volume of the reaction chamber is sampled per minute. If no care is taken to limit this volume the sampling may lead to a change in composition within the reactor, thus leading to an undesired change in kinetics.

Preferably the reaction chamber has an effective reaction chamber volume and the sampling and transfer means are adapted to remove samples each having an effective sample volume of 1/100,000- 1/10, more preferably 1/50,000- 1/100, most preferably 1/10,000- 1/1000, of said effective reaction chamber volume.

It is also preferred to design the flow restrictor such that a sample volume of 1/100,000- 1/10, preferably 1/50,000- 1/100, more preferably 1/10,000- 1/1000, of said effective reaction chamber volume is removed per minute.

To avoid or reduce the problem of clogging of the flow restrictor 13 clogging elimination means can be provided, such as a very thin needle piercing the bore of the flow restrictor at intervals or a backwash arrangement wherein transfer fluid or the like is flushed back through the flow restrictor by increasing the pressure thereof to the same pressure as in the reaction chamber or above that.

In a possible embodiment one or more capillaries replace the insert 12 with microhole 13, preferably in parallel if multiple capillaries are used.

Preferably the capillary or bundle of capillaries has a ratio between the length and the fourth order of internal diameter between 100 and 10⁷ meter per mm⁴.

In another possible embodiment the flow restrictor is a porous body, e.g. a porous membrane or a porous frit.

In yet another embodiment the flow restrictor is a sieve.

FIG. 2

In FIG. 2 the batch reactor vessel 20 of a second system according to the invention is shown. In particular the reactor vessel 20 could form part of an array of multiple vessels 20 in a system for conducting parallel small-scale chemical experiments. The reactor vessel 20 is formed by a liner 21 having a bottom 22 and sidewall 23 as well as an opening at the top. The liner 21 is received in a well 24 in a base 25. A lid 26 closes off the opening of the liner 21.

The vessel 20 has a reaction chamber 27 of small volume, e.g. between 1 and 50 ml.

An annular space 28 is present between the base 25 and the lower end part of the liner 21. In the base 25 an inlet channel 30 and an outlet channel 31 are provided connecting to the annular space 28. Via said inlet and outlet channels 30, 31 and space 28 a transfer fluid flow can be established.

The reaction chamber 24 is connected to said space 28 via a sample removal passages 33 formed in the liner 21, preferably in the form of one or more microholes as explained above.

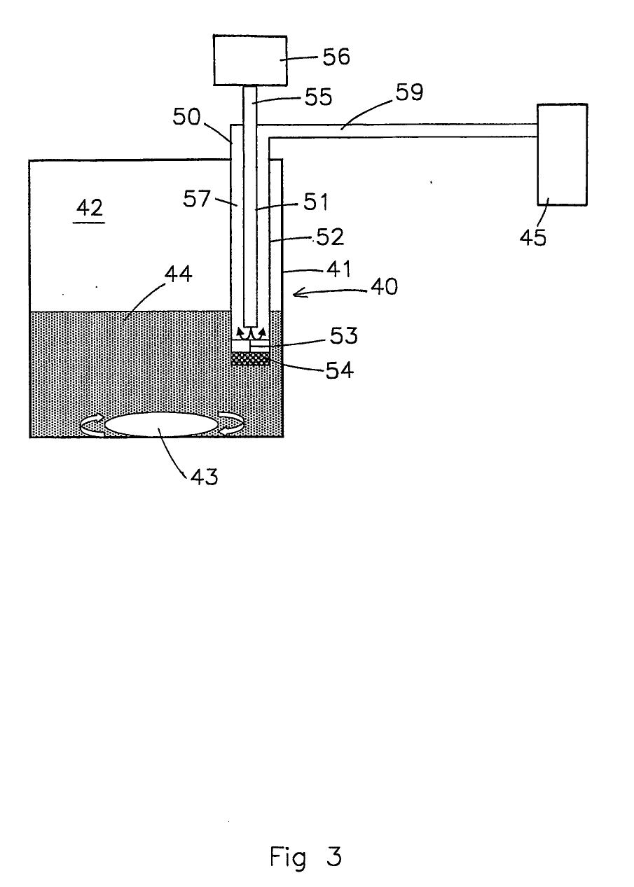

FIG. 3

In FIG. 3 a third exemplary embodiment of a system for conducting a chemical experiment is shown. The system comprises a batch reactor vessel 40 having a wall 41 defining a reaction chamber 42. The vessel 40 is of the stirred tank type having a stirrer 43 for stirring the liquid chemical mixture 44 involved in the chemical experiment.

In order to determine relevant parameters of the experiment an analysis apparatus 45 is provided remote from said reactor vessel 40 for analysing samples of the reaction mixture 44 removed from the reaction chamber 42.

In the wall 41 of the reactor vessel 40 an aperture is provided wherein an insert 50 is mounted.

The insert 50 is a coaxial assembly of an inner tubular element 51 and an outer tubular element 52. The outer tubular element 51 is provided with one or more sample removal passages in communication with the reaction chamber 42, here a disc is fitted in the axial end of tubular element 52 and provided with a single microhole 53.

A filter 54 is placed in front of this sample removal passage to avoid clogging of the microhole 53.

The inner tubular element 51 has an inlet 55 connected here to a source 56 of transfer fluid. The inner tubular element 51 further has an outlet in communication with the space 57 between the inner and outer tubular elements 51, 52. The outer tubular element 52 has an outlet 59 connected to this space 57 so that transfer fluid can enter into said space via the inner tubular element 51 and be discharged via outlet 59. The outlet connects to a further part of the transfer fluid conduit, which connects to analysis apparatus 45.

In particular the outlet of the inner tubular element 51 is near the sample removal passage 53, so that the transfer fluid immediately takes along the sample.

It will be apparent that the diameters of the inner and outer tubular element can be small as long as the microhole is the flow restrictor in the path between the reaction chamber and the analysis apparatus.

The advantage of such system is the fact that such an insert can be placed in any existing reactor having an aperture of large enough to accommodate the insert. Another advantage is the fact that the system allows a lot of flexibility for the position of the inlet of the sample removal passage within the reactor.

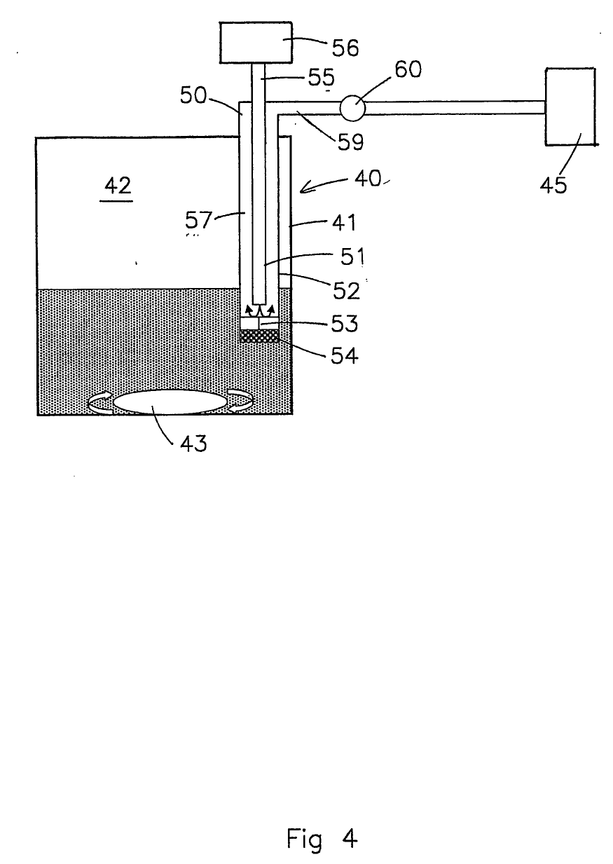

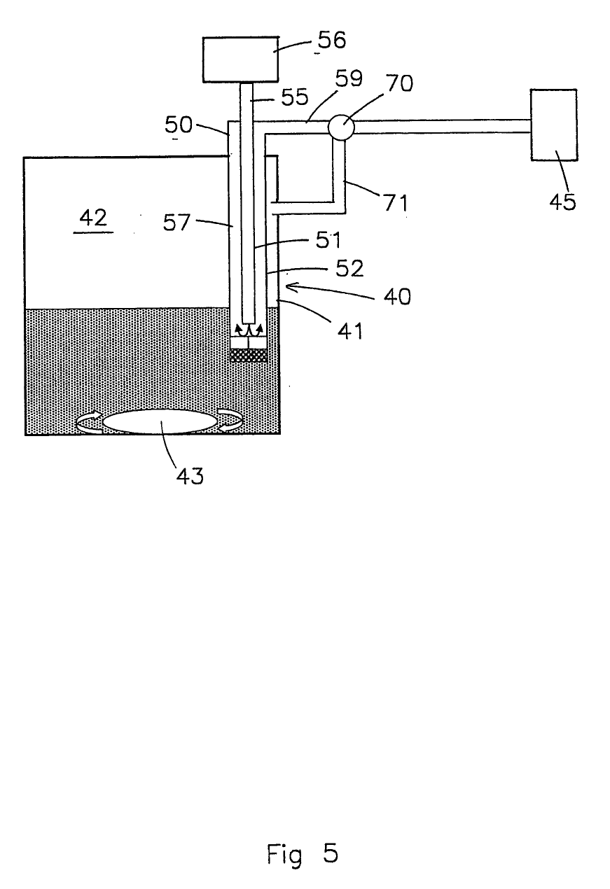

FIG. 4

In the embodiment shown in FIG. 4 the same parts as shown in FIG. 3 have the same reference numerals.

In order to control the flow of samples across the flow restrictor a backpressure regulator 60 is provided in the transfer passage, which basically allows control of the pressure of the transfer fluid and thus of the pressure drop across the flow restrictor 53.

The advantage of such a system is the fact that it can be used for application conditions where high pressures are present in the reactor. Under those conditions, if a high pressure drop across the flow restrictor were present, it would be difficult to construct a restrictor with a small enough internal diameter to control the flow rate through that restrictor. A small internal diameter also is more prone to blockage. Using a backpressure regulator will allow smaller pressure drops over the restrictor, thus allowing a larger internal diameter of the flow restrictor.

FIG. 5

In the embodiment shown in FIG. 5 the same parts as shown in FIG. 4 have the same reference numerals.

In this embodiment the backpressure regulator 70 is adapted to maintain an essentially constant pressure drop across the flow restrictor. The conduit 71 between the reaction chamber 42 and the regulator 70 is an exemplary solution to supply the regulator 70 with the actual value of the pressure in the reaction chamber. It will be apparent that entirely different arrangements are also possible including the use of a first pressure sensor for detecting the pressure in the reaction chamber and a second pressure sensor for detecting the pressure of the transfer fluid. A controller could then be provided which is connected to the first and second pressure sensors, which controller is further connected to backpressure regulator for the purpose of setting the pressure drop across the flow restrictor and thereby influencing the sample flow. The advantage of this system amongst others is the fact that the pressure drop across the restrictor will be constant irrespective of the pressure within the vessel. As the restriction also does not change during the experiment, the flow rate will remain constant, even when the pressure within the reactor changes.

The concept as explained in FIGS. 4 and 5 can obviously also be applied to a continuous flow reactor and is not necessarily limited to a batch reactor system as shown.

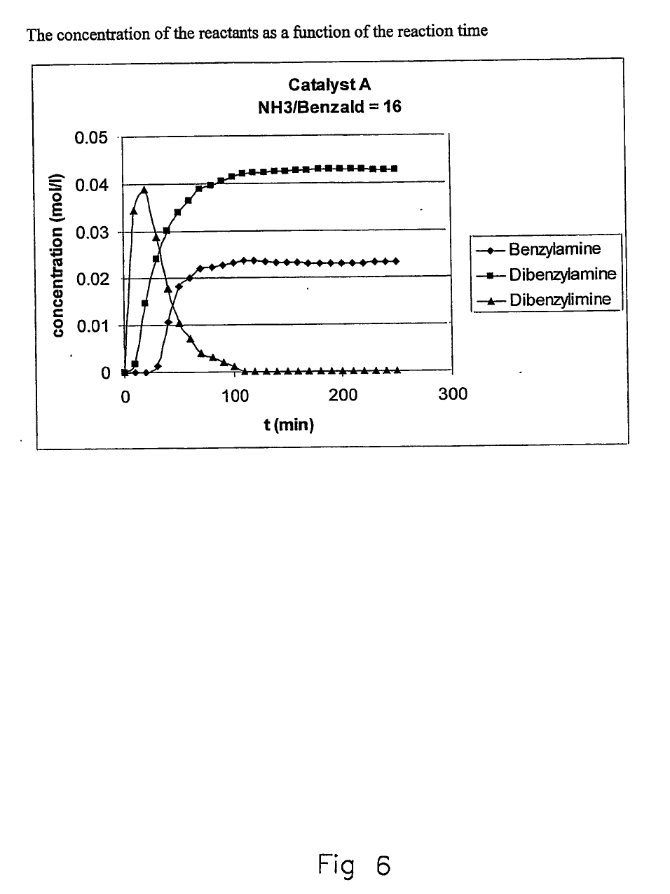

FIG. 6

In FIG. 6 a graph is shown related to an experiment conducted with a system as shown in FIG. 5. This experiment involves the reductive amination of benzaldehyde to benzylamine.

A Parr 4842 stirred autoclave reactor having an internal volume of 160 ml was equipped with a sampling system as shown in FIG. 3.

A flow restrictor was used in the sampling system having a length of 4 mm and an internal diameter of about 13 micrometer.

A butylacetate liquid consisting of 1 mg/l toluene as an internal standard was pumped through the transfer fluid conduit 15 at a flow rate of 0.5 ml/min.

A 6.6 M NH₃ solution in MeOH (23 mL) was introduced into the reactor. Methanol (57 mL), the catalyst (0.017 g), benzaldehyde (1 g) and cyclohexane internal standard (1 g) were added.

The reaction mixture was heated to 90° C. under a N₂ atmosphere at 1 bar. After 1 h, a 40 bar H₂ pressure was applied.

With a sample collection robot at the outlet of the transfer conduit samples were taken at regular intervals of 10 minutes. At the beginning of each 10 minutes interval one minute was used to fill a sampling vial in the robot with 0.5 ml of the effluent from the conduit 15. During the remaining 9 minutes the effluent was sent to waste.

The samples were analysed with a Varian Star 3400 gas chromatograph (CP Sil-5 CB Column) applying a temperature gradient from 50 to 300° C. The cyclohexane internal standard was used to calculate the absolute concentrations of the individual components. From the cyclohexane to toluene concentration ratio the flow through the capillary was estimated to be 40 microliter per minute.

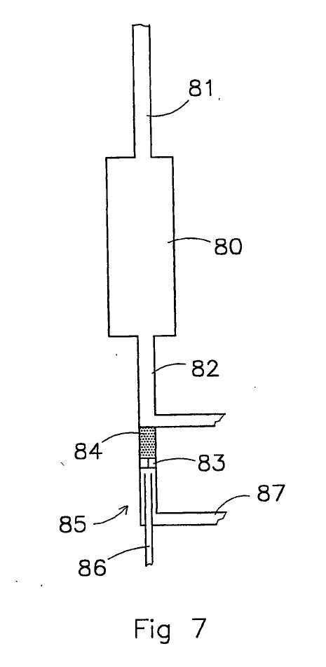

FIG. 7

In FIG. 7 another system according to the invention is shown.

The reactor vessel is a continuous flow reactor 80 having an inlet 81, e.g. for a gas/liquid flow. The reactor vessel 80 has an outlet 82. Said outlet 82 has a collector space 84 for the liquid effluent. In communication with said space 84 a sample removal passage 83 is provided for removing a sample flow. In this example an arrangement 85 is employed basically of the structure as shown in FIGS. 3, 4 and 5 having a coaxial sampling assembly with an inlet 86 for a transfer fluid and an outlet 87 to be connected to an analysis apparatus.

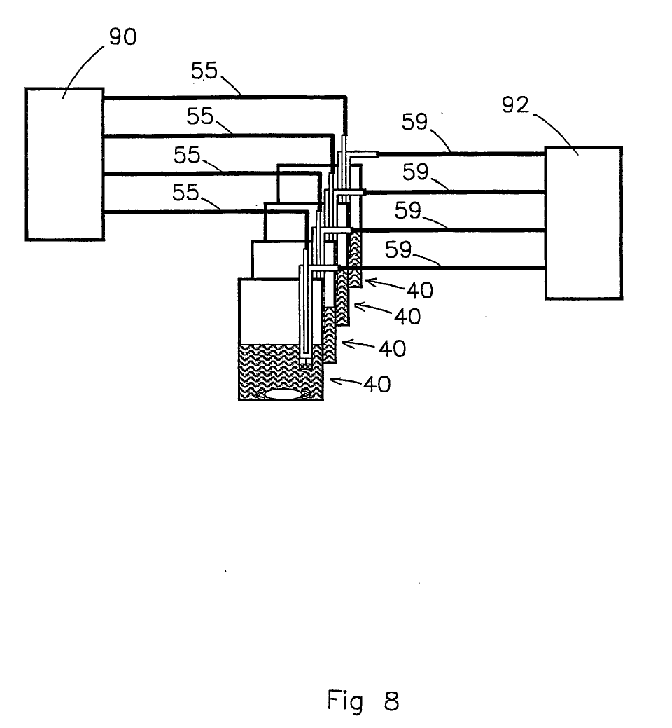

FIG. 8

In the embodiment shown in FIG. 8 a parallel arrangement is shown of the reactors 40 of which one individual reactor is shown in FIG. 3. The transfer fluid inlet conduit 55 of the reactors 40 are connected to a common transfer fluid supply means 90. The transfer fluid conduits 59 are connected (e.g. via a selector valve) to a common analysis apparatus 92.

The common transfer fluid supply means 90 can include a system of parallel pumps, e.g. peristaltic pumps, or a single pump or other pressure source followed by parallel flow restrictors or flow distributors in the conduits 55. Such systems are well known for decades for equally distributing flows over a number of channels.

The common analysis apparatus 92 may comprise a multiport selection valve selecting one of the streams for analysis, or may comprise a sample collection system for collecting the samples in a parallel array of collection tubes. These tubes may subsequently be use for off-line analysis. Another possibility is to use a spectroscopic system with a multitude of optical cuvettes. The light beam passing these cuvettes may be multiplexed before entering the spectrophotometer.

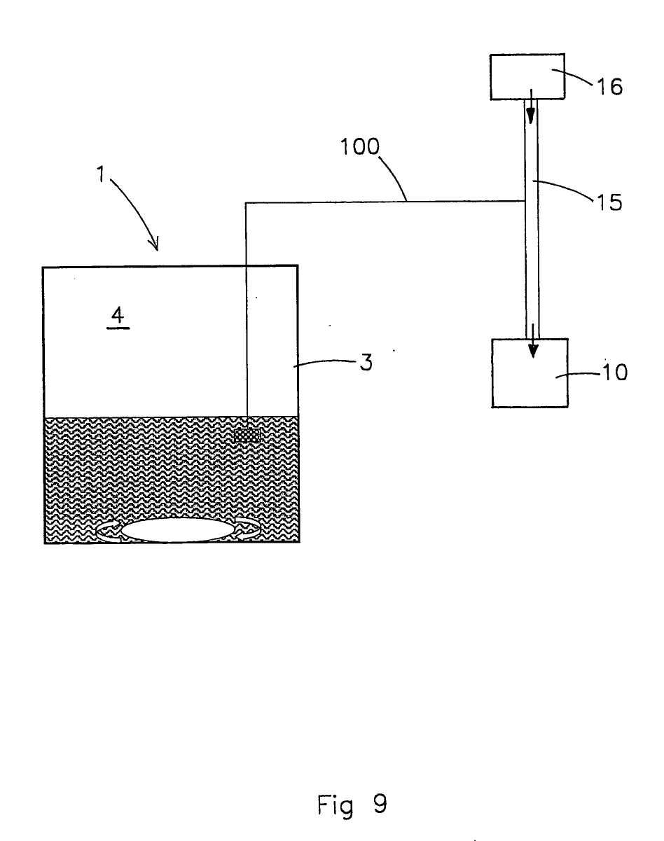

FIG. 9

FIG. 9 shows a system that is conceptionally similar to FIG. 1. The reference numerals in FIG. 9 correspond to those shown in FIG. 1. The main difference is the fact that the flow restrictor 100, which forms the entire the sample removal passage here, consists of a capillary tube which extends both inside the reactor 1 as well as outside the reactor 1. This system will in some cases provide more flexibility, especially when little space is available close to the reactor wall 3. It also will allow more flexibility for the placement of the inlet of the sample removal passage 100 in the reaction chamber 4.

It will be apparent that this configuration may also be configured in a parallel way similar to FIG. 8.

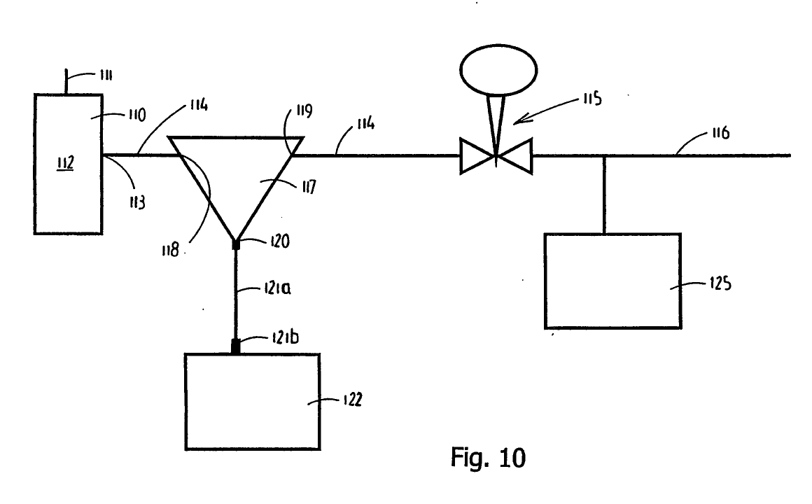

FIG. 10

FIG. 10 shows a reactor vessel 110, in particular a high-pressure reactor vessel 110, in this example of the continuous flow type having an inlet 111 for one or more reagents (gas and/or liquid), a reaction chamber 112 and an outlet 113 for an effluent stream containing gas and liquid.

The reactor outlet 113 is connected to an effluent conduit 114 for discharging the effluent from the reaction chamber 112.

The effluent conduit 114 is connected to a backpressure regulator 115 for controlling the pressure in the reaction chamber 112, such that the chemical experiment is conducted in a high-pressure condition, e.g. above 10 bar.

The backpressure regulator 115 is connected to a vent conduit 116 for venting the effluent passing the backpressure regulator 115.

A gas/liquid separator 117 is received in the effluent conduit 114, which separator 117 has an inlet 118 and a first outlet 119 connected to the effluent conduit 114 and a second outlet 120 for separated liquid.

A sample removal passage 121a is connected to said second outlet 120, so that the sample removal passage 121a is in open communication with the interconnected reaction chamber 112 and effluent conduit 114 upstream of the pressure controller 115, thus the high-pressure in the reaction chamber 112 is also present at the entrance of the passage 121a.

The sample removal passage 121a is connected to a sample transfer passage 121b, which is in this embodiment essentially formed by a connector on an analysis apparatus 122, so that sampled liquid is are fed to the apparatus 122. The sample removal passage 121a contains a flow restrictor such that the pressure drop over said flow restrictor causes the removal of liquid from the separator 117.

The system is advantageously used in a high-pressure situation wherein a reactor pressure is present in said reactor vessel, which pressure is above 5 bar, preferably above 10 bar, more preferably above 20 bar.

By suitable dimensioning of the sample removal passage for such a high-pressure experiment the effect can be obtained that a sample pressure is present in said transfer passage, said pressure being below 4 bars absolute, preferably below 2 bar absolute, more preferably below 1.5 bar absolute.

In a particular situation it is envisaged that the flow resistance of the passage 121a is so high that in case of liquid flow through this passage 121a the residual liquid pressure at the end of the passage 121a connected to the analysis apparatus 122 essentially corresponds to atmospheric pressure or at least a pressure well below the operating pressure in the reaction chamber 112, preferably at most 20% of the operating pressure.

In general the operating pressure in the reactor vessel 112 thus acts directly on the backpressure regulator 115 and the pressure drop to ambient pressure occurs over this backpressure regulator.

In this arrangement the sampled liquid “leaks” from the separator outlet 120. If the analysis apparatus 122 contains a shut-off valve the leaking can be effected at desired intervals or the like, or it can be envisaged that the leaking of sampled liquid takes place during the entire experiment, e.g. in case the apparatus 122 does not have such a shut-off valve.

It is noted that the apparatus 122 can be a sample collector, e.g. having a dispenser for dispensing the sampled liquid into one or more collection containers.

In a preferred embodiment the entire sample removal passage 121a is embodied as a capillary tube having a small diameter, thus providing the desired flow resistance.

In an alternative embodiment the sample removal passage and the sample removal passage are embodied as a unitary part having no non-discriminatable elements.

In FIG. 10 a further analysis apparatus 125 is provided for analysis of the gaseous effluent downstream of the backpressure regulator 115.

It will be apparent that the sample removal passage 121a can be embodied in many alternative manners as disclosed above, e.g. having a microhole or needle valve as flow restrictor. A filter could be present at the entrance of the passage 121a to prevent clogging. The filter preferably would have a pore size smaller than the diameter of the flow restrictor.

It will also be apparent that the sample and transfer passages 121a, 121b could be embodied as described above, wherein a transfer fluid is added downstream of the flow restriction in the passage 121a.

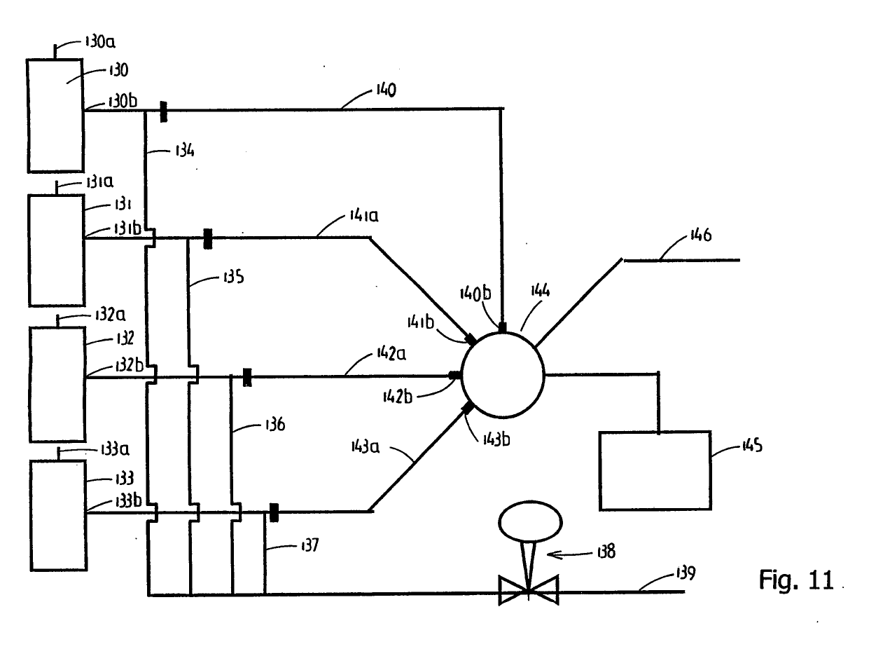

FIG. 11

In FIG. 11 a system is shown having four parallel reactor vessels 130, 131, 132, 133 of the continuous flow type, each having an inlet 130a, 131a, 132a, 133a for one or more reagents and an outlet 130b, 131b, 132b, 133b for an effluent stream. The outlets are connected to effluent conduits 134, 135, 136, 137 respectively which are connected to a common backpressure regulator 138 for controlling the pressure in the reaction chambers of the vessels 130,131,132, 133 so that high pressure experiments can be conducted in parallel, whereby each reactor operates at an equal pressure. The backpressure regulator 138 is connected to a vent conduit 139.

The system further comprises multiple sample removal and transfer passages 140a, 140b, 141a, 141b, 1421, 142b, 143a, 143b, each sample removal passage establishing an open communication between effluent conduit 134, 135, 136, 137 and the associated transfer passage.

The sample removal passages 140a-143a are mounted between connectors at either end. The connectors 140b-143b on the end remote from the reactors from the sample transfer passages and are mounted on a selector valve 144 interposed between said sample removal and transfer passages 140-143 and an analysis apparatus 145, so that it is possible to feed one of the sample flows to the apparatus 145 while the other flows are vented via vent conduit 146.

In this system the sample removal passages 140a-143a each have such a high flow resistance that although the entrance of each passage 140a-143a is in open communication with the reactor vessel the residual pressure at the end of the passage 140a-143a is essentially the ambient pressure or at most a pressure well below the operating pressure in the reactor vessel, e.g. at most 20% of the operating pressure.

Due to the high flow resistance of the passages 140a-143a the selector valve 144 is in a low-pressure zone of the system, which allows a far less complex and expensive design of the selector valve than in prior art systems where the selector valve itself is subjected to the operating pressure in the reactor vessels.

In a practical embodiment the passages 140a-143a are formed by capillary tubes, preferably having the same length and inner diameter.

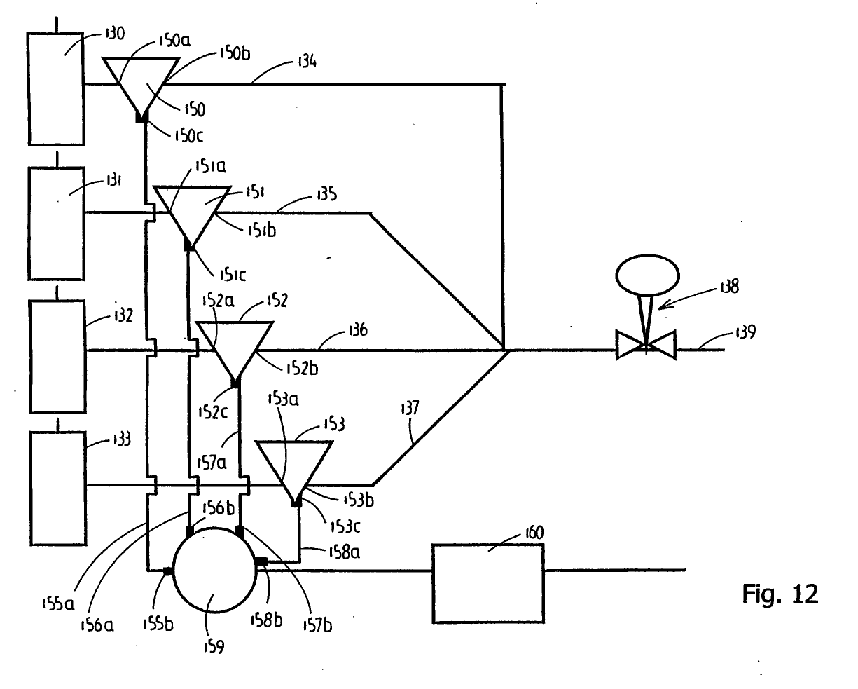

FIG. 12

In FIG. 12 a variant of the system of FIG. 11 is shown. This system comprises the reactor vessels 130-133 connected to effluent conduits 134-137, which are connected to common backpressure regulator 138.

The effluent stream emerging from each of the reactor vessels 130-133 which are operated in parallel during the experiment contain gaseous and liquid components. In order to separate these components a gas/liquid separator 150-153 is received in each of the effluent conduits 134-137. Each gas/liquid separator 150-153 has an inlet 150a-153a in open communication with the reactor vessel outlet, a first outlet 150b-153b connected to the effluent conduit 134-137 at the side of the backpressure regulator 138, and a second outlet 150c-153c for separated gas or liquid.

Each second outlet 150c-153c is connected to an associated sample removal passage 155a-158a, which are connected at their other end via a connector forming a sample transfer passage 155b-158b to a selector valve 159. The selector valve 159 allows for the connection of one of the passages 155-158 to an analysis apparatus 160.

In a practical embodiment the sample removal passages 155a-158a are formed by capillary tubes having equal length and inner diameter.

In this system, as in the system of FIG. 11, the sample removal passages 155a-158a have such a high flow resistance that although transfer passages 155b-158b are in open communication with the associated reactor vessel, the residual pressure of the sample liquid or gas at each transfer passage 155b-158b can be the ambient pressure whilst the reactor can operate at very high pressures (over 100 bar). This allows for a simple design selector valve 159.

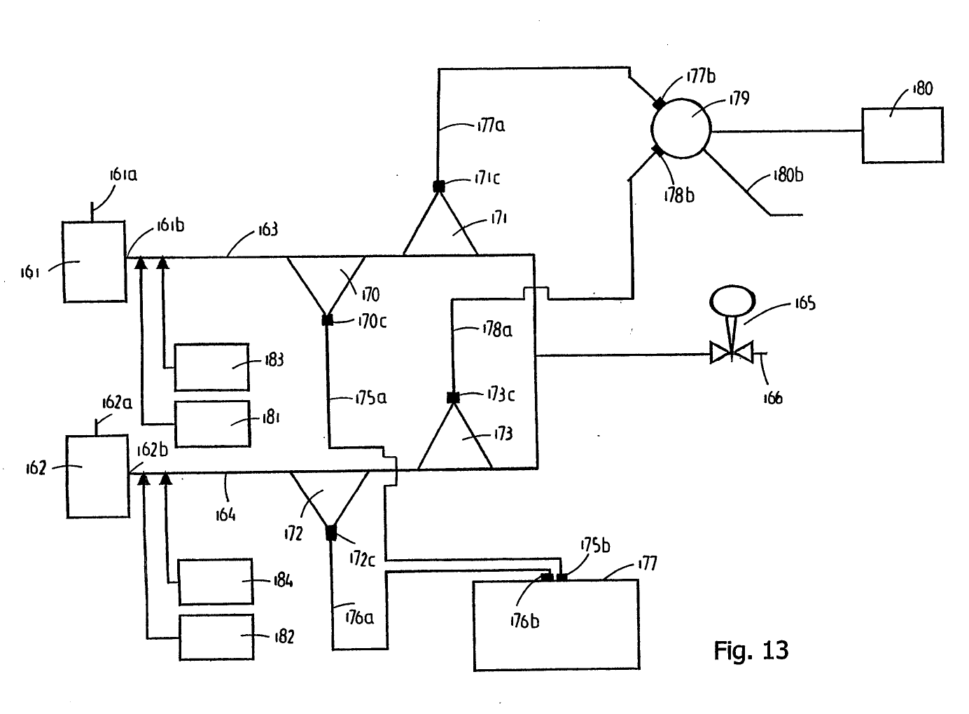

FIG. 13

In FIG. 13 a system is shown having two reactor vessels 161, 162 of the continuous flow type each having an inlet 161a, 162a and an outlet 161b, 162b connected to an associated effluent conduit 163, 164. The effluent conduits 163, 164 connect to a common backpressure regulator 165, which leads to a vent conduit 166.

The effluent stream for each of the reactor vessels 161, 162 contains a liquid and a gaseous component. In order to analyse the reactions during the experiments in the reactor vessels 161, 162 provision is made for the extracting of sample flows of liquid and gas from the effluent streams during the experiments. For this reason a first gas/liquid separator 170, 172 and a second gas/liquid separator 171, 173 are placed in series in each of the effluent conduits 163, 164.

In this example the first gas/liquid separators 170, 172 each have an outlet 170c, 172c for separated liquid, while the second gas/liquid separators 171, 173 each have an outlet for separated gas. The remainder of the effluent stream is led to the vent conduit 166 via backpressure regulator 165.

An associated sample removal passage 175a, 176a connects each outlet 170c, 172c to a liquid analysis apparatus 177 via a connector forming the sample transfer passage 175b, 176b.

An associated sample removal passage 177a, 178a connects each outlet 171c, 173c to a selector valve 179 via a connector forming the sample transfer passage 177b, 178b, which allows for the feeding of one of the gaseous sample flows to a gas analysis apparatus 180 or a vent conduit 180b.

Each of the sample removal passages 175a-178a provides such a high flow resistance for the associated sampled fluid that at the end remote from the gas/liquid separator 170-173 the pressure preferable is the ambient pressure. This allows for a simple design of the selector valve 179 as well as the liquid analysis apparatus 177 directly connected to the passages 175, 176.

In the system of FIG. 13 also provision is made for diluent feed means for diluting the effluent streams emerging from the reactor vessels 161, 162 upstream of the first gas/liquid separators 170, 172. In this example liquid diluent feed means 181, 182 as well as gaseous diluent feed means 183, 184 are shown.

It will be apparent that the reactor vessels of FIGS. 10-13 could also be batch reactor vessels allowing the discharge of effluent from the reaction chambers.

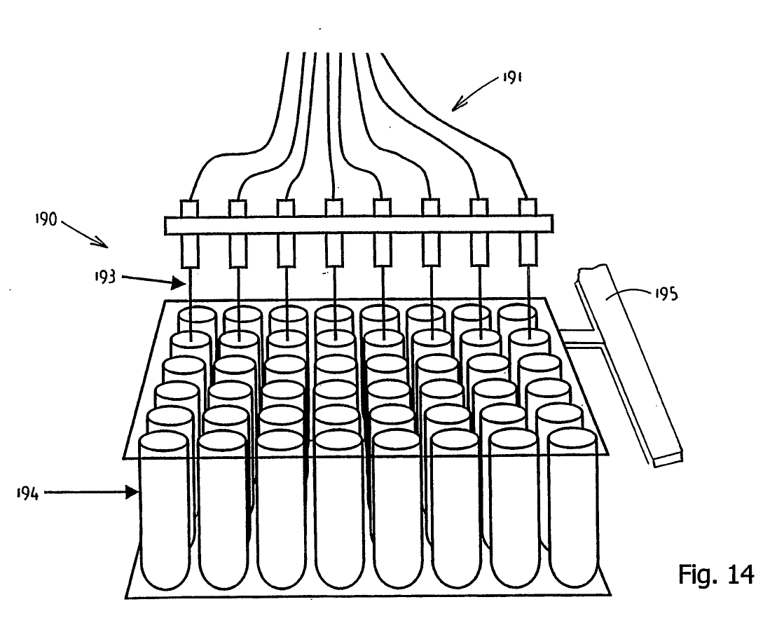

FIG. 14

FIG. 14 shows a possible embodiment of the liquid analysis apparatus in a system such as that of analyser 144 in FIG. 11, or analyser 159 in FIG. 12, or analyser 177 in FIG. 13. In the embodiment of FIG. 14 the liquid analysis apparatus 190 has eight parallel reactor vessels and as many liquid sample removal and transfer passages 191.

This apparatus 190 is a parallel liquid sample collector, which comprises an array of outlets 193 formed by needles, for depositing sampled liquid in parallel in an array of collection containers 194 positionable with respect to the needles 193.

An automated drive 195 is provided for providing a step by step motion of the rows of collection containers 194 so that each row of containers is filled with sampled liquid stemming from a certain interval of the experiments conducted in parallel.

It will be apparent that a parallel sample collector can also be embodied to handle gaseous sample flows in parallel, wherein it is immaterial whether the reactor vessels from which the samples stem are batch reactors or continuous flow reactor vessels. For instance the collection vessels 194 could have a membrane to be pierced by the needles for feeding a gas into the collection vessels.

The invention also relates to a system for performing parallel chemical experiments, comprising:
multiple reactor vessels arranged in parallel, each having a reaction chamber, an inlet and an outlet,
multiple sample removal and transfer passages, each in communication with an associated reactor vessels,
a parallel sample collection apparatus having multiple outlets each connected to an associated sample removal and transfer passage, and multiple collection vessels allowing deposition in parallel of samples into said vessels.

1. A system for performing a chemical experiment, comprising:
a reactor vessel having a wall defining a reaction chamber for receiving one or more fluids performing a chemical reaction,
an analysis apparatus remote from said reactor vessel for analysing samples of said one or more fluids removed from said reaction chamber,
sampling means and transfer means adapted for removing samples of said one or more fluids from said reaction chamber and transferring said samples to said analysis apparatus,
said sampling and transfer means comprise a sample removal passage in communication with said reaction chamber and a sample transfer passage connected to said sample removal passage and extending to said analysis apparatus, wherein
said sample removal passage establishes an open communication between said reaction chamber and said sample transfer passage, and wherein
said sample removal passage contains a flow restrictor, and wherein
a pressure drop over said flow restrictor causes the removal of said samples from the reaction chamber.

2. A system according to claim 1, wherein said system further includes a transfer fluid supply means that feeds a transfer fluid into said transfer passage, said transfer fluid transferring said sample through said transfer passage to said analysis apparatus.

3. A system according to claim 1, wherein said system further includes a transfer fluid supply means that feeds a transfer fluid into said transfer passage, said transfer fluid transferring said sample through said transfer passage to said analysis apparatus, and wherein a pressure controller is provided that establishes a controlled pressure drop over said flow restrictor which causes a controlled removal of said samples from the reaction chamber.

4. A system according to claim 1, wherein said flow restrictor forms said sample removal passage.

5. A system according to claim 1, wherein said system further includes a transfer fluid supply means that feeds a transfer fluid into said transfer passage, said transfer fluid transferring said sample through said transfer passage to said analysis apparatus, and wherein said transfer fluid supply means are adapted to create a constant flow of said transfer fluid, such that a sample is transferred to said analysis apparatus in a continuous manner.

6. A system according to claim 1, wherein said system comprises multiple reaction chambers and wherein a common analysis apparatus is provided, said system allowing the transfer of samples of a significant number of said reaction chambers to said analysis apparatus.

7. A system according to claim 1, wherein said system comprises multiple reaction chambers and multiple sample transfer passages and wherein a common transfer fluid feeding apparatus is provided, said system allowing distribution of the transfer fluid to a significant number of said reaction chambers.

8. A system according to claim 1, said system further includes a transfer fluid supply means that feeds a transfer fluid into said transfer passage, said transfer fluid transferring said sample through said transfer passage to said analysis apparatus, wherein said transfer fluid is a solvent for the sample.

9. A system according to claim 1, wherein said reactor vessel has a reactor outlet connected to an effluent conduit for discharging effluent from the reaction chamber, and wherein said effluent conduit is connected to a pressure controller for controlling the pressure in the reaction chamber, and wherein the sample removal passage is in open communication with the interconnected reaction chamber and effluent conduit upstream of the pressure controller.

10. A system according to claim 9, wherein a first gas/liquid separator is received in the effluent conduit, said first gas/liquid separator having a first outlet connected to the effluent conduit and a second outlet for separated gas or liquid, and wherein said sample removal passage is connected to said second outlet.

11. A system according to claim 10, wherein a second gas/liquid separator is received in the effluent conduit downstream of the first gas/liquid separator, said second gas/liquid separator having a first outlet connected to said effluent conduit and a second outlet for separated gas or liquid, and wherein a second sample removal passage is connected to said second outlet.

12. A system according to claim 10, wherein said system comprises multiple reactor vessels, the effluent conduits being connected to a common pressure controller for controlling the pressure in the reaction chambers, and wherein the system comprises multiple sample removal and transfer passages, each sample removal passage being in open communication with an associated effluent conduit.

13. A system according to claim 12, wherein said multiple sample transfer passages are connected to a selector valve interposed between said sample removal and transfer passages and an analysis apparatus.

14. A system according to claim 13, wherein said multiple sample removal and transfer passages are connected to a parallel analysis apparatus for conducting analysis of sample fluids from the reactors in parallel.

15. A system according to claim 14, wherein said multiple sample removal and transfer passages are connected to a parallel sample collector.

16. A system according to claim 15, wherein said parallel sample collector comprises an array of outlets, each in communication with a sample transfer passage, and an array of collection containers positionable so that samples are deposited in parallel in said containers.

17. A system according to claim 1, wherein said system further includes a transfer fluid supply means that feeds a transfer fluid into said transfer passage, said transfer fluid transferring said sample through said transfer passage to said analysis apparatus, and wherein a pressure regulator is provided in said transfer passage that controls the pressure of the transfer fluid and thereby the pressure drop over the flow restrictor.

18. A system according to claim 17, wherein said pressure regulator is adapted to maintain an essentially constant pressure drop across the flow restrictor.

19. A system according to claim 1, wherein said system further includes a transfer fluid supply means that feeds a transfer fluid into said transfer passage, said transfer fluid transferring said sample through said transfer passage to said analysis apparatus, and wherein said sample removal passage is essentially formed by said flow restrictor and wherein said sample is received by said transfer fluid directly downstream of said flow restrictor.

20. A system according to claim 1, wherein said system further includes a transfer fluid supply means that feeds a transfer fluid into said transfer passage, said transfer fluid transferring said sample through said transfer passage to said analysis apparatus, and wherein said transfer fluid supply means are adapted to create a periodic flow of said transfer fluid, such that in the absence of flow of transfer fluid a sample is formed as a slug in said transfer passage, which slug is displaced through said transfer passage upon presence of the flow of transfer fluid.

21. A system according to claim 1, wherein said flow restrictor has constant dimensions.

22. A system according to claim 1, wherein said flow restrictor forms said sample removal passage.

23. A system according to claim 1, system further includes a transfer fluid supply means that feeds a transfer fluid into said transfer passage, said transfer fluid transferring said sample through said transfer passage to said analysis apparatus, wherein said transfer fluid is immiscible with said sample.

24. A system according to claim 1, wherein said transfer fluid feed means are adapted to create an alternating flow of a transfer liquid and a transfer gas.

25. A system according to claim 1, wherein the system further includes a transfer fluid supply means that feeds a transfer fluid into said transfer passage, said transfer fluid transferring said sample through said transfer passage to said analysis apparatus, and wherein said transfer fluid feed means are adapted such that the ratio between the flow of transfer fluid and the flow of sample fluid is between 1 and 1×10⁶.

26. A system according claim 1, wherein said reaction chamber has an effective reaction chamber volume and said sampling and transfer means are adapted to remove samples each having an effective sample volume of 1/100,000- 1/10 of said effective reaction chamber volume.

27. A system according to claim 1, wherein said flow restrictor is dimensioned such that a sample volume of 1/100,000- 1/10 of said effective reaction chamber volume is removed per minute.

28. A system according to claim 1, wherein said reactor vessel is a continuous flow reactor vessel having an outlet from which a volumetric flow of reactor effluent is discharged, and wherein said flow restrictor is dimensioned such that a volumetric sample flow is established which amounts to 0.001 to 0.99 of the volumetric flow of the reactor effluent.

29. A system according to claim 1, wherein said flow restrictor comprises at least one capillary having a length.

30. A system according to claim 29, wherein said capillary has a ratio between the length and the fourth order of internal diameter between 100 and 10⁷ meter per mm⁴.

31. A system according to claim 1, wherein said flow restrictor is a porous body.

32. A system according to claim 1, wherein said reaction chamber has an effective reaction chamber volume between 0.5 ml and 2000 ml.

33. A system according to claim 1, wherein said analysis apparatus comprises a sample collector system.

34. A system according to claim 1, wherein said reactor vessel is a batch reactor vessel and is adapted for receiving a liquid having a liquid surface and said sample removing passage has an entrance that is located below said liquid surface.

35. A system according to claim 1, wherein said reactor vessel is a continuous flow reactor and the sample removal passage has an entrance that is located at a downstream end of the flow reaction chamber.

36. A system according to claim 1, wherein said flow restrictor comprises at least one microhole.

37. A system according to claim 36, wherein a microhole has a internal diameter between 1 and 50 micrometer.

38. A system according to claim 36, wherein said microhole is formed in the wall of said reactor vessel, so that said samples are removed from said reaction chamber via said microhole.

39. A system according to claim 36, wherein a mounting aperture is present in said wall of said reactor vessel in which an insert provided with said microhole is fastened.

40. A system according to claim 39, wherein said insert is a tubular element protruding through said mounting aperture into said reaction chamber and being provided with said microhole at a location inside said reaction chamber.

41. A system according to claim 40, wherein said tubular element has an axial end inside said reaction chamber, said axial end being closed by an insert having said microhole.

42. A system according to claim 40, wherein said insert is a coaxial assembly of an inner tubular element and an outer tubular element, said assembly having an inlet for a transfer fluid and an outlet for transfer fluid transferring said samples, the outer tubular element being provided with said microhole and said inner tubular member being in communication with a space between said inner and outer tubular element, a circulation means being provided for causing a circulation of transfer fluid through said assembly.

43. A system according to claim 1, wherein the system further comprises diluent feed means for diluting effluent emerging from a reactor vessel upstream of a connection of the sample removal and transfer passage.

44. A method for performing a chemical experiment, wherein use is made of a system comprising:
a reactor vessel having a wall defining a reaction chamber for receiving one or more fluids performing a chemical reaction,
an analysis apparatus remote from said reactor vessel for analysing samples of said one or more fluids removed from said reaction chamber,
sampling means and transfer means adapted for removing samples of said one or more fluids from said reaction chamber and transferring said samples to said analysis apparatus,
said sampling and transfer means comprise a sample removal passage in communication with said reaction chamber and a sample transfer passage connected to said sample removal passage and extending to said analysis apparatus,
wherein said sample removal passage establishes an open communication between said reaction chamber and said sample transfer passage, and wherein said sample removal passage contains a flow restrictor, and wherein a pressure drop over said flow restrictor causes the removal of said samples from the reaction chamber.

45. A method according to claim 44, wherein during the experiment a fraction of a reactor content continuously leaks out of the reactor through said sample removal passage.

46. A method according to claim 44, wherein said system further includes a transfer fluid supply means that feeds a transfer fluid into said transfer passage, said transfer fluid transferring said sample through said transfer passage to said analysis apparatus, and wherein the system further includes a pressure controller that establishes a controlled pressure drop over said flow restrictor which causes the controlled removal of said samples from the reaction chamber, and wherein the method includes controlling the pressure of the transfer fluid for the purpose of influencing the flow of samples through the flow restrictor.

47. A method according to claim 44, wherein an internal standard is added to the one or more fluids in the reaction chamber.

48. A method according to claim 46, wherein an internal standard is added to the transfer fluid.

49. A method according to claim 44, wherein said reactor vessel is a continuous flow reactor vessel, and wherein an effluent is discharged from said reactor vessel, said effluent containing a liquid.

50. A method according to claim 44, wherein a reactor pressure is present in said reactor vessel, which pressure is above 5 bar.

51. A method according to claim 44, wherein a sample pressure is present in said transfer passage, said pressure being below 4 bars absolute.

52. A method according to claim 44, wherein said reactor vessel is a continuous flow reactor vessel having an outlet from which a flow of reactor effluent is discharged, and wherein said flow restrictor is dimensioned such that a volumetric sample flow is established which amounts to 0.001 to 0.99 of the volumetric flow of the reactor effluent.
